(19) United States
(12) Patent Application Publication
(10) Pub. No.: US 2010/0327195 A1
(43) Pub. Date: Dec. 30, 2010

(54) LOW-POWER OPTOCOUPLER

(76) Inventors: Lei Huang, Beijing (CN); Qing Liao, Beijing (CN)

Correspondence Address: GRAYBEAL JACKSON LLP, 400 - 108TH AVENUE NE, SUITE 700, BELLEVUE, WA, 98004, US

(21) Appl. No.: 12/493,575

(22) Filed: Jun. 29, 2009

(51) Int. Cl. G02B 27/00

(52) U.S. Cl. 250/551

(57) ABSTRACT

An embodiment of an optocoupler may provide electrical isolation between signals on a driver side and signals on a receiver side of the optocoupler by generating light signals via a fiber-optic link to the receiver. One embodiment includes driver circuit that may receive an input signal (or a series of input signals) having a specific clock cycle. Instead of driving a light source, such as a light-emitting diode, for the entire duration in which an input signal may be at a high logic level, the LED may be driven with only a pulse to indicate any transitions from high-to-low or from low-to-high. In another embodiment, a receiver circuit may then interpret pulses of differing widths to reconstruct a series of logical signal from only its pulse transitions. By limiting the amount of time in which the LED is on, yet still conveying all underlying data in the input signal, the optocoupler reduces the overall power needed during operation.

### BACKGROUND

In electronics, a light-emitting diode (LED) optocoupler may be used to provide electrical isolation between two electronic circuits that pass signals between them. For example, this may allow the two circuits to have grounds that are at different voltage potentials. Applications for such isolation may include, for example, automobile electronics wherein an ignition system communicates with, but may be electrically isolated from, an on-board computer system. Another application may be maintain electrical isolation between a primary side and a secondary side of a power supply by optocoupling a feedback signal the secondary side to the primary side.

A conventional optocoupler includes an input node coupled to a transmitter circuit that is configured to drive an LED. When an input signal at the input node is at a high logic level, the LED may be turned “on”, i.e., activated, and when the input signal is at a low logic level, the LED may be turned “off”, i.e., deactivated. The LED may be positioned next to (or optically coupled with) a receiver circuit having a photo diode that may be operable to generate a signal having a first level in the presence of light and having a second signal in the absence of light. Thus, when light is present (i.e., the LED is on), the photo diode may generate a high logic level signal, and when no light (or a level of light below a threshold of the photo diode) is detected (i.e., the LED is off), the photo diode may generate a low logic level signal.

One potential problem with a conventional optocoupler is inefficient power consumption. In order to generate, e.g., a high logic level in the receiver side circuit, the LED in the transmitter side circuit must remain on for the duration of the high logic level signal at the input node. Similarly, the photodiode also remains on as long as light is detected from the LED. As a result, the LED and photo diode remain on and consume power at a duty cycle that is equivalent to duty cycle of the input signal. Furthermore, because the LED may not immediately transition from on to off (or vice versa), pulse width distortion (PWD) may be introduced. That is, there exists a finite amount of time necessary for the LED to turn off, and during that time, light begins to dissipate at a specific rate. If this rate of dissipation is too slow, the photo diode in the receiver circuit may interpret a high logic level signal to be present longer than it actually is present ion the input signal. Thus, the output signal derived from the detected light may be distorted with respect to the input signal.

### BRIEF DESCRIPTION OF THE DRAWINGS

Embodiments of the subject matter disclosed herein will become more readily appreciated as the same become better understood by reference to the following detailed description, when taken in conjunction with the accompanying drawings.

FIG. 1 is a block diagram of an embodiment of a low-power optocoupler.

FIG. 2 is a timing diagram for signals utilized in an embodiment of a method for reducing power consumption in the optocoupler of FIG. 1.

FIG. 3 is a block diagram of an embodiment of a driver circuit that may be part of the low-power optocoupler of FIG. 1.

FIG. 4 is a circuit diagram of an embodiment of a data translator that may be part of the driver circuit of FIG. 3.

FIG. 5 is a block diagram of an embodiment of a receiver circuit that may be part of the low-power optocoupler of FIG. 1.

FIG. 6 is a circuit diagram of an embodiment of a signal conditioning circuit that may be part of the receiver circuit of FIG. 5.

FIG. 7 is a circuit diagram of an embodiment of a time comparator circuit that may be part of the receiver circuit of FIG. 5.

FIG. 8 is a circuit diagram of another embodiment of a time comparator circuit that may be part of the receiver of FIG. 5.

FIG. 9 is a block diagram of an embodiment of a system that may include the low-power optocoupler of FIG. 1.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the subject matter disclosed herein. This disclosure is not intended to be limited to the embodiments shown, but is to be accorded the widest scope consistent with the principles and features disclosed or suggested herein.

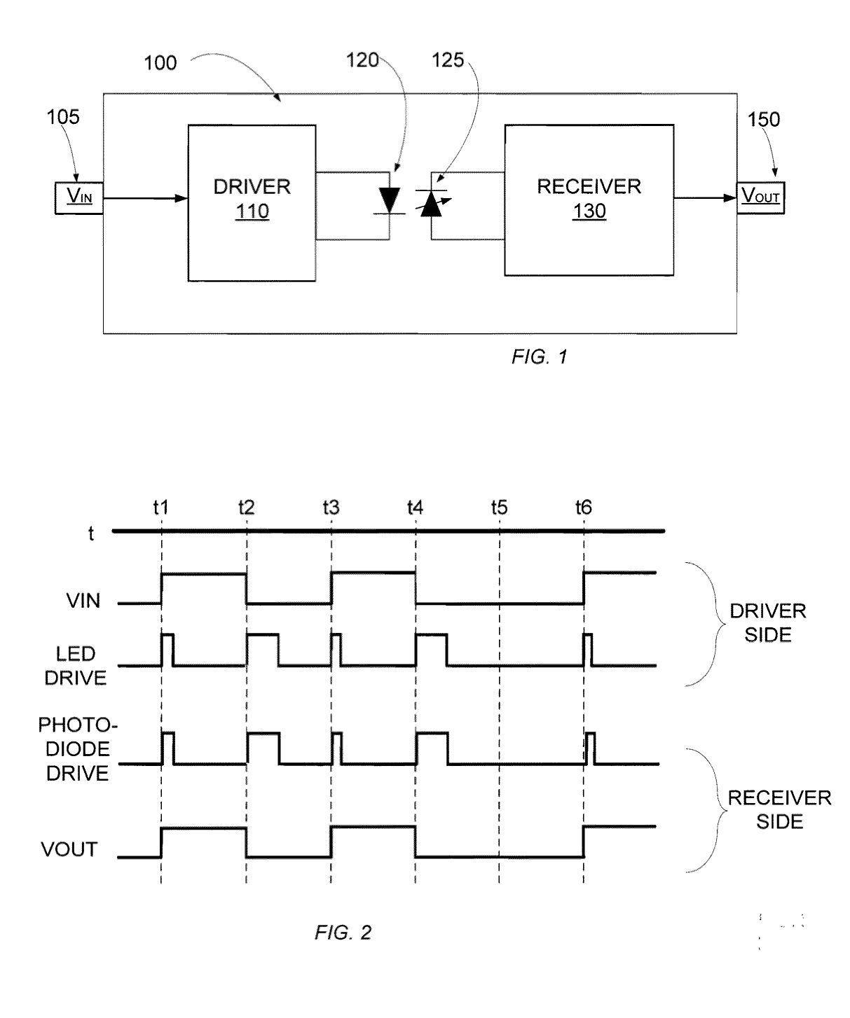

FIG. 1 is a block diagram of an embodiment of a low-power optocoupler 100. The optocoupler 100 provides electrical isolation between signals on a driver side (e.g., the left-hand side of the optocoupler 100 as generally associated with the driver 110) and signals on a receiver side (e.g., the right-hand side of the optocoupler as generally associated with a receiver 130). The optocoupler 100 includes an input node 105 that may receive an input signal (or a series of input signals) from an electrically or communicatively coupled circuit (not shown) which is to be electrically isolated on the driver side of the optocoupler 100. The driver 110 receives the input signal and conditions the input signal to drive a light-emitting diode (LED) 120 that is coupled to the driver circuit. As will be described in greater detail below, the driver circuit 110 interprets the input signal and generates an LED drive signal that turns on the LED for less time or with less power.

The input signal may typically be binary data represented as a series of logical ones and zeros (e.g., a one is a high logical value and zero is a low logical value). If the input signal is at a logical high level, it represents a datum of one and if the input signal is at a logical low value, it represents a datum of zero. In an effort to preserve power, the optocoupler interprets these two scenarios differently and drives the LED in a manner which consumes less power overall. Thus, if the input signal is at a high logic level, instead of driving the LED with a full signal for the entire time that the input signal is at a high logic level, the drive circuit 110 may generate an LED drive signal having a different representative parameter such as a signal having a shorter duration or a signal having a smaller amplitude. If the input signal is at a low logic level, then the drive circuit 110 may generate an LED drive signal at a second, different duration or amplitude. Driving the LED 120 with shorter-duration signals or smaller-amplitude signals results in the LED being on for less time or with less power consumption.

On the receiver side of the optocoupler 100, a photo-diode 125 may be located proximate to the LED 120 so as to detect light from the LED. The photo-diode 125 then generates a signal that is proportionate to the level of light detected (e.g., the signal generated becomes larger as more light is detected). The photo-diode 125 is coupled to a receiver circuit 130 that may interpret the amplitude and duration of signals generated by the photo-diode 125. Much like the generation of the LED drive signal on the driver side but in a reciprocal manner, the receiver circuit 130 may interpret a signal having a first duration or amplitude as a low logic level signal and a signal having a second duration or amplitude as being a high logic level signal. The receiver circuit 130 may then condition the newly generated signal from the photo diode to be passed to an output node 150, such that the signal at the input node 105 will be substantially replicated at the output node despite the output node being electrically isolated from the input node by the optocoupler 100.

With such an optocoupler 100, power consumption may be reduced if the LED is powered on for less time or with less intensity. In conventional optocouplers, the LED 120 would be driven at a duty cycle equivalent to a respective input signal at the input node 105. That is, if the input signal is a high logic level signal, the LED 120 is on until the input signal transitions to a low logic level signal. Keeping the LED 120 on for the entire duration of a high logic level signal consumes power for the duration in which the LED is on. However, embodiments described herein only turn on the LED 120 for a short duration to represent a high-logic level signal (as opposed to the entire time). An example operation of such an optocoupler 100 will be better understood with reference to the example timing diagram of FIG. 2 described below.

FIG. 2 is a timing diagram for signals utilized in an embodiment of a method for reducing power consumption in the optocoupler 100 of FIG. 1. By way of example, a specific system may be configured to operate at 10 MHz. Thus, incoming signals are clocked every 100 ns (and consequently, may transition from high to low (or vice versa) every 100 ns). In FIG. 2, the interval between each consecutive pair of times t1, t2 t3, etc. may represent a time duration of the inverse of the speed of the system. Thus, t1 may be t=100 ns, t2 may t=200 ns, etc.

At t1, the input signal V_{IN} may be a high logic level signal representing an underlying datum of one. Its voltage level is high for the duration of the 100 ns between t1 and t2. In a conventional optocoupler (not shown), the LED would then be energized for the full 100 ns. However, the LED 120 of FIG. 1 may only be driven for a short duration of time to convey the logic level (i.e., convey the data) of the input signal. In this embodiment, this duration is 10 ns as can be seen for the LED DRIVE signal at t1. Generally speaking, instead of keeping the LED 120 on for the entire time that the input signal is at a high logic level, the LED 120 need only be energized long enough to convey the edge information (rising or falling edge) of the input signal.

Next, the photo-diode 125 may also generate a signal equivalent to the LED drive signal as can be seen at t1 on the PHOTO-DIODE DRIVE plot. The receiver side may then interpret a 10 ns signal to be representative of a high logic level signal at V_{IN} and subsequently, generate a VOUT signal that as also a high logic level signal that is substantially the same as V_{IN} from t1 to t2. In an embodiment, the receiver 130 maintains VOUT at a high logic level until the photo diode receives a signal indicating a falling-edge transition of the input signal to a low logic level as described below.

At t2, the input signal V_{IN} may transition to a low logic level signal (representing an underlying datum of logical zero). Then, the drive circuit may generate a signal of a different duration (e.g., different from the 10 ns that represents a high logic level) for driving the LED. As can be seen at t2, the LED DRIVE signal may be a signal with a longer duration of 40 ns (but still less than 100 ns). Subsequently, the photo-diode generates a signal having a duration of 40 ns. The receiver side may then interpret a signal of 40 ns to represent an underlying datum of zero. Thus, at t2, V_{OUT} is a low logic level and is again substantially similar to V_{IN}. In an embodiment, the receiver 130 maintains V_{OUT} at a low logic level until the photo diode receives a signal indicating a rising-edge transition of the input signal to a high logic level.

FIG. 2 shows a similar situation with respect to t3 and t4 wherein the input signal again transitions to high at t3 and back to low at t4. Consequently, signals of 10 ns and 40 ns are generated (on the driver side) and interpreted (on the receiver side) such that V_{OUT} is substantially similar to V_{IN}. At t5, a scenario is shown where V_{IN} does not transition to a different logic level at the next timing interval. Rather, V_{IN} remains at a logical low value. Thus, because V_{IN} has no edge, no signal is generated by the driver side as no transition is needed on the output signal a the node 150. Although not shown in FIG. 2, a similar scenario may occur when consecutive high-logic-level signals occur for V_{IN}.

At t6, however, the input signal transitions high again. Thus, a 10 ns signal is generated on the driver side and interpreted on the receiver side such that the output signal also transitions to a high logic level.

From the foregoing, it can be seen that the optocoupler 100 of FIG. 1 may generate an electrically isolated signal on a receiver side by interpreting a signal received optically from a driver side such that the driver input signal and the receiver side output signal are substantially similar. The drive circuit 110 is operable to receive an input signal including a parameter (here voltage level) indicative of data carried by the input signal. The driver circuit 110 may then generate a first signal (LED DRIVE) corresponding to the received input signal such that this first signal includes a different parameter than the input signal that is indicative of the underlying datum. That is, the duration of the signal now indicates the underlying data. Thus, a signal having a width of only 10 ns may represent a high logic level signal instead of a signal that is at a higher voltage for the entire duration between t1 and t2. Similarly, the receiver circuit may receive the driver-side-generated signal (via the photo-diode), and interpret this signal to generate an output signal (V_{OUT}) that is the same as the input signal V_{IN}.

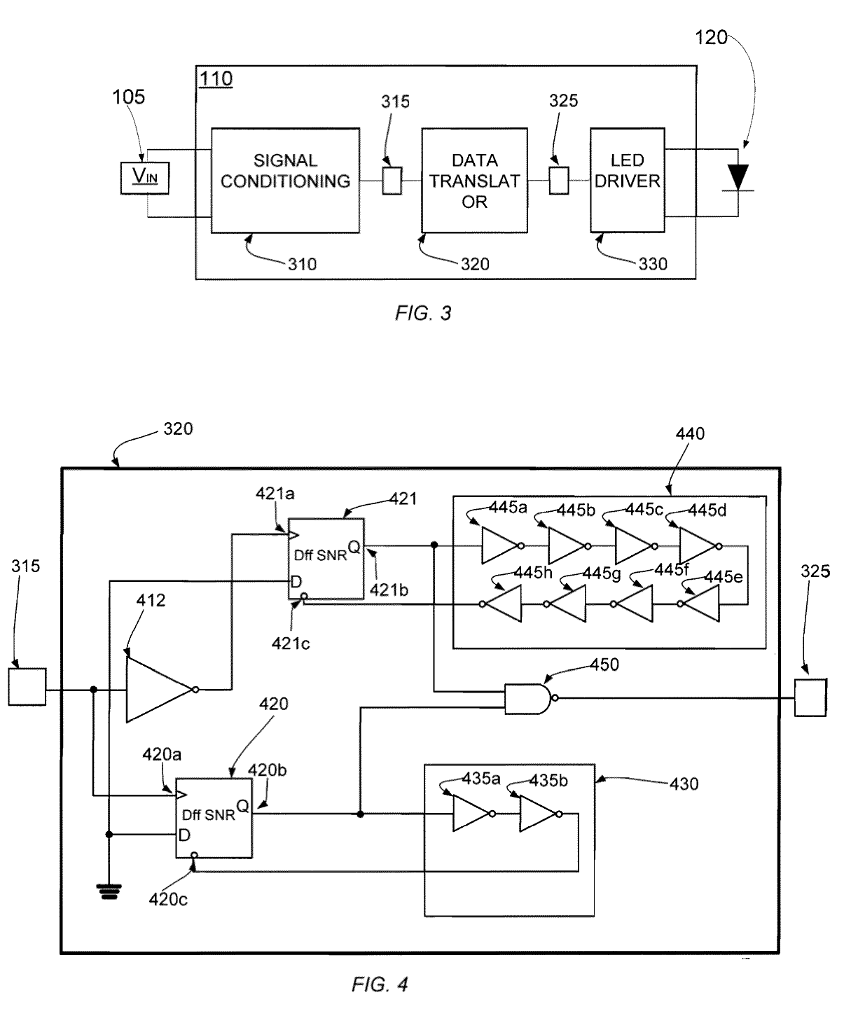

Such an optocoupler may be realized on a single integrated circuit or on multiple integrated circuits. For example, the driver circuit may be located remotely from the receiver circuit such that light energy is transmitted from the LED to the photodiode via a fiber-optic connection. Further, the optocoupler may have various components or functionality realized via firmware or software. The particular example signal widths discussed above are suitable for circuitry supporting a speed up to 10 MHz wherein each data bit comprises a duration of 100 ns. However, other circuitry speeds and corresponding signal durations may be realized for faster or slower circuitry. Thus, the signal widths may be reduced to accommodate greater circuit speeds. Or, the driver circuit 110 may generate the LED DRIVE signal having a lower amplitude but a duration that spans the entire time between consecutive times t for V_{IN} being a logic one, and having a substantially zero amplitude by a duration that spans the entire time between consecutive times t for V_{IN} being a logic zero. Or, the driver circuit 110 may generate the LED DRIVE signal having both a shorter duration and a lower amplitude. The forgoing driver side and receiver side circuits are described in greater detail below in conjunction with FIGS. 3-8.

FIG. 3 is a block diagram of an embodiment of the driver circuit 110 of FIG. 1. An input signal (V_{IN} of FIG. 2) may be received at an input node 105 of the driver circuit 110. As discussed above, the input signal V_{IN} typically comprises a series of logic level signals having high and low voltages representing high and low logic levels as is known in the industry. The input signal may then be passed to a signal conditioning block 310 via node 315 The signal conditioning block 310 (not shown in detail herein) conditions the received signal such that any spurious signals or unwanted noise is removed before translating the signal at a data translator.

Next the conditioned signal may be passed to a data translation block 320 via node 325 where the incoming signal may be interpreted and translated by the data translator 320. The data translator 320 may generate a different signal that still conveys the underlying data, but using a different signal parameter to do so. Thus, a signal having a different parameter (e.g., duration, amplitude) defining the underlying data is generated and passed to an LED driver 330 that drives the LED 120. For example, the translator 320 may generate a signal that is similar to the LED DRIVE signal of FIG. 2. The data translator 320 is described in greater detail below with respect to FIG. 4.

FIG. 4 is a circuit diagram of an embodiment of the data translator 320 of FIGS. 2-3. A conditioned input signal may be passed to the data translator at node 315. This node 315 may be a circuit node corresponding to an output of a signal condition block (310 of FIG. 3) such that the incoming data signal may comprise a series of logic high and logic low values.

The incoming signal is passed to a first D-type flip-flop 420 and to a second D-type flip-flop 421. The second D-type flip-flop 421 receives an inverted signal as the incoming signal is passed through an inverter 412. Each of these signals is coupled to the clocked inputs 420a and 421a of the respective D-type flip-flops 420 and 421. Each flip flop 420 and 421 has its D-input coupled to ground as well. Thus, each D-type flip-flop 420 and 421 will output a low logic level signal on its respective output 420b and 421b when its clocked input detects a transition from low logic level to high logic level (i.e., a rising edge). The outputs 420b and 421b of each D-type flip-flop 420 and 421 remains at a low logic level until a low logic level signal is received at a respective reset node 420c and 421c. Additionally, each D-type flip-flop output 420b and 421b is coupled to a NAND gate 450 which is, in turn, coupled to node 325 (coupled to the LED driver 330 of FIG. 3).

In operation, the lower D-type flip-flop 420 may be used to generate a 10 ns signal on node 325 in response to detecting a rising edge (transition from logic zero to logic one) on node 315, and the upper D-type flip-flop 421 may be used to generate a 40 ns signal on the node 325 in response to detecting a falling edge (transition from logic one to logic zero) on node 315. Thus, when the input signal transitions from a low logic level to a high logic level and a rising edge is present at node 315, the lower D-type flip-flop sets its output 420b to a low logic level. Because the signal is inverted (at inverter 412) the clocked input to the upper D-type flip-flop 421 sees a falling edge, which does not trigger the upper D flip-flop; consequently, the output Q of the upper D flip-flop 421 remains at logic one.

The output 420b of the lower D-type flip-flop 420 is coupled to an input of the NAND gate 450 and, therefore, sets the output of the NAND gate to a high logic level. This signal remains at a high logic level until the lower D-type flip-flop 420 is reset. The reset node 420c is coupled to the output node 420b via a series of two inverters 435a and 435b which not only inverts the signal twice, but also delays the signal by approximately 5 ns per inverter. Thus, after 10 ns (two 5 ns delays), the lower D-type flip-flop 420 is reset and its output transitions back to a high logic level, thus causing the output of the NAND gate 450 and the node 325 to transition to a low logic level.

Similarly, the upper D-type flip-flop may detect a falling edge (transition from logic one to logic zero) of a signal at node 315 (which the inverter 412 converts into a rising edge). Thus, when the input signal transitions from a high logic level to a low logic level and a rising edge is present at node 315, the lower D-type flip-flop 420 remains inactive, and thus continues to generate a logic one at its Q output 420b. But the clock input to the upper D-type flip-flop 421 is a rising edge, which sets the flip-flop output 421b to a low logic level.

The output 421b of the upper D-type flip-flop 421 is also coupled to an input of the NAND gate 450 and, therefore, sets the output of the NAND gate to a high logic level. This signal remains at a high logic level until the upper D-type flip-flop 421 is reset. The reset node 421c is coupled to the output node Q of the flip-flop 421 via a series of eight inverters 445a-445h, which not only inverts the signal eight times, but also delays the signal by approximately 5 ns per inverter. Thus, after 40 ns (eight 5 ns delays), the upper D-type flip-flop 421 is reset and its output transitions back to a high logic level, and the output of the NAND gate 450 transitions back to low.

In summary, the data translator 320 detects the edges of any signal that may be received at node 315. If a rising edge is detected, then a 10 ns signal is generated on node 325 to indicate a transition of the input signal (node 105 of FIG. 1) to a logic one. If a falling edge is detected at node 315, then a 40 ns signal is generated at node 325 to indicate a transition of the input signal to a logic 0. If there is no edge detected (i.e., the signal at node 315 remains at a high or low logic level for another clock cycle), then there is no need to generate a signal as the logical output translated at the receiver will also remain at the same logic state.

Other embodiments may use signal widths other than 10 ns and 40 ns to represent rising and falling edges. Additionally, signals with different amplitudes may be generated in response to detecting a rising or falling edge at node 315. For example, a signal having an amplitude of 60 mV may be used to represent a high logic level and a signal having an amplitude of 120 mV may be used to represent a signal having a low logic level, or vice versa.

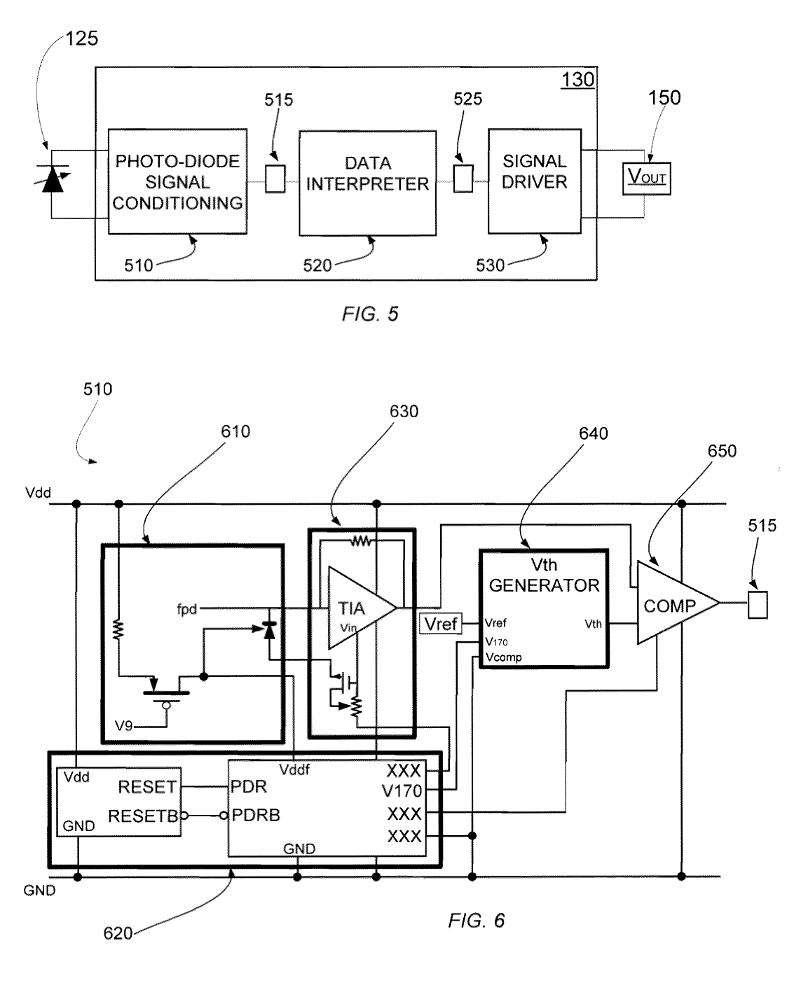

The LED 120 (FIG. 1) may then be driven according to the signal as generated on node 325. The LED 120 turns on and generates light which may be transmitted to the photo-diode 125 (FIG. 1), which is part of the receiver side 130 of the optocoupler 100 (FIG. 1). The photo-diode 125 may be positioned next to (e.g., on the same integrated circuit chip as) the LED 120 (as shown in FIG. 1) or may be positioned remotely such that any optical signal is transmitted to the receiver via fiber optic cable or the like. In any case, an optical signal as driven by the LED 120 may be received by a photo-diode 125. The receiver side is described below with respect to FIGS. 5-8.

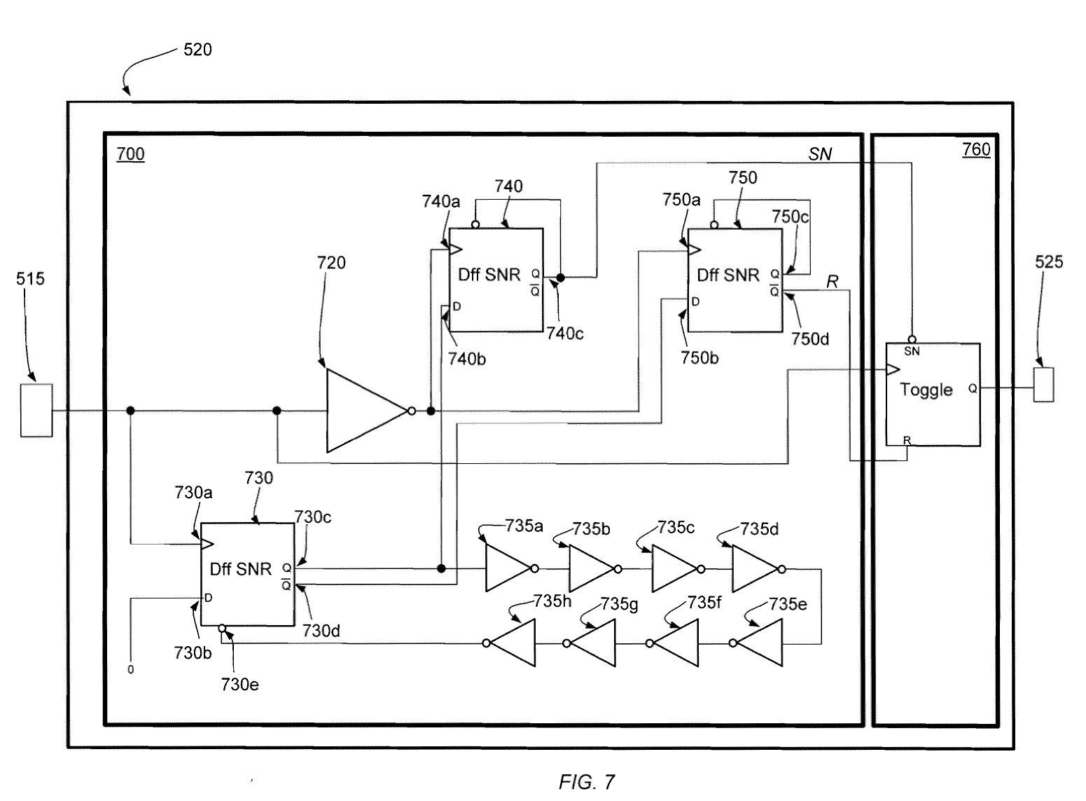

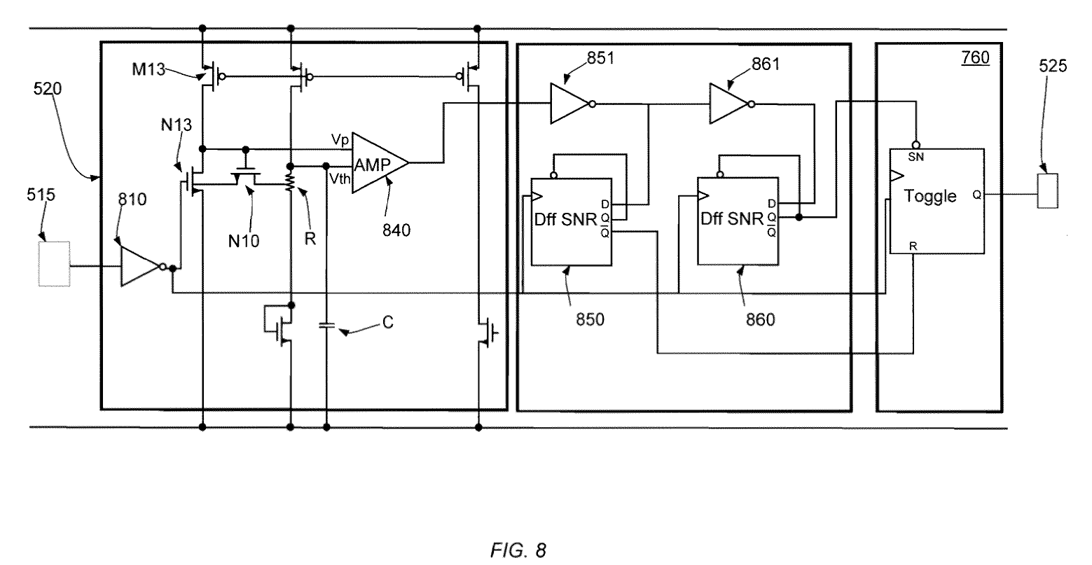

FIG. 5 is a block diagram of an embodiment of the receiver circuit 130 of FIG. 1. The receiver circuit 130 includes the photo-diode 125, which may detect light that is incident on the photo-diode and generate a signal based upon the intensity of the light. The photo-diode 125 is coupled to a signal conditioning circuit 510, which is described below in conjunction with FIG. 6. The conditioned signal may be passed to a data interpreter 520, which is described below in conjunction with FIGS. 7 and 8, via a node 515. The interpreted signal may be passed via a node 525 to a signal driver 530, which is coupled to an output node 150.

FIG. 6 is a circuit diagram of an embodiment of a photo-diode signal conditioning circuit 510 of FIG. 5. The photo-diode 125 may be part of a circuit 610, which together with voltage and current bias circuitry 620, may condition the signal generated by the photo diode 125 to provide more distinct transitions between a high logic signal and a low logic signal. The conditioned signal may be passed to a trans-impedance amplifier 630 (TIA) for amplification, and the amplified signal is input to a first input node of a comparator 650. Additionally, a threshold generator 640 generates a threshold signal that is input to a second input node of the comparator 650.

The output of the comparator 650 is then a signal that mimics the on time and of time of the received optical signal. That is, the comparator 650 outputs a high logic level signal while the optical signal is on (i.e., light is detected) and outputs a low logic level signal while the optical signal is off (i.e., no light is detected). In other words, the comparator 650 generates signal levels that correspond to the levels of the LED signal in the timing diagram of FIG. 2. This signal is then passed to the data interpreter as described below in conjunction with FIGS. 7 and 8.

FIG. 7 is a circuit diagram of an embodiment of the data interpreter circuit 520 of FIG. 5. The data interpreter circuit 520 may include a time comparator circuit 700 and toggle flip-flop 760. The time comparator circuit 700 is coupled to the node 515 and receives the signal generated by the photo-diode 125 and conditioned by the signal conditioning circuit 510 (as both shown in FIG. 5). The output of the flip-flop 760 is coupled to the node 525. As is described in further detail below, the data interpreter circuit 520 interprets signals received at the node 515 to generate at node 525 a corresponding signal that mimics the input signal V_{IN} at node 105 of FIG. 1.

In operation of an embodiment of the interpreter 520, a signal at node 515 will typically either be a 10 ns signal (representing a rising edge at V_{IN} of FIG. 1) or a 40 ns signal (representing a falling edge at V_{IN} of FIG. 1). If the signal at node 515 is a 10 ns signal, then the resulting output signal at node 525 needs to transition to a high logic level if it is not already at a high logic level. Likewise, if the signal at node 515 is a 40 ns signal, then the resulting output signal at node 525 needs to transition to a low logic level if it is not already at a low logic level. These two different signals cause different control signals in the time comparator circuit 700, as discussed below.

Consider the case of the 10 ns signal first. As the rising edge of the 10 ns signal is detected at the D-type flip-flop 730 at its clock node 730a, an output signal at its Q-node 730c transitions low while an output signal at its inverted Q-node 730d transitions high. This is because its D-input 730b is coupled to a low-voltage rail (as represented by logical 0 in FIG. 7). Q-node 730c is coupled to a chain of delay elements 735a-735h (inverters) that loop back to the reset node 730e of the lower flip-flop 730. The delay chain may introduce a total delay of more than about 10 ns but less than about 40 ns before a signal can propagate back to the reset node 730e of the lower flip-flop 730. This delay is used to determine whether or not to transition the output at node 525 as is discussed further below.

Additionally, the Q-node 730c is coupled to the D-input 740b of the upper left D-type flip-flop 740. Further, the inverted Q-node 730d of the lower flip-flop 730 is coupled to the D-input 750b of the upper right D-type flip-flop 750. Both the upper D-type flip-flops 740 and 750 are clocked by the inverse of the signal at node 515 via inverter 720.

At the rising edge of a signal at node 515, the Q-node 730c of the lower flip-flop 730 is set to low and the inverted Q-node 730d is set to high. In turn, there will be a low logic signal on the D-input 740b to the upper left flip-flop 740 and there will be a high logic signal on the D-input 750b on the upper right flip-flop 750. At this moment, the Q output 740c (signal SN) of the flip flop 740 and the inverted Q output 750d (signal R) of the flip flop 750 are both ready to be set to a low logic level. However, because the clock input 740a and 750a for each flip flop 740 and 750 has yet to receive a rising edge(e.g., a falling edge at node 515), the SN signal remains at a high logic level (its default state) and the R signal remains at a low logic level.

The values of signals SN and R depend upon whether a falling edge of a signal at node 515 occurs before or after the lower flip-flop 730 is reset, i.e., before the initial low signal that comes out of the flip-flop has a chance to propagate through the delay circuit 735a-735h and back again before a falling edge occurs at the node 515. The low logic value at the Q-node 730c of the lower flip-flop 730 begins to traverse through the delay circuit 735a-735h. Once this signal propagates through the delay circuit 735a-735h, it resets this flip-flop 730 and thus cause the Q-node 730c to be set to a high logic level and the inverted Q-node 730d to fall to a low logic level.

In the case of a 10 ns signal at node 515, the lower flip-flop 730 will not have a chance to be reset by the delay circuit signal. After 10 ns, a falling edge at node 515 occurs and this causes a rising edge on the clock inputs of both upper flip-flops 740 and 750. Because there is a low logic level already on the Q-node 730c of the lower flip-flop 730 (and consequently, the D-input 740a of the upper left flip-flop 740), the clocking of the upper left flip-flop 740 causes the signal SN to transition low. This signal pulses low for 1-2 ns because the upper left flip-flop 740 is substantially immediately reset (e.g., within 1-2 ns) by this very output signal. Further, because there is a high logic value on the inverted Q-node 730d of the lower flip-flop and thus a high logic value on the D-input 750a on the upper right flip-flop 750, the signal R which comes from the inverted Q-node 750d of the upper right flip-flop 750, stays low.

The signal SN pulsing low causes the output of the toggle flip-flop 760 to transition to a high logic level (if it is not already at a high logic level). Thus, when a 10 ns signal is detected at node 515, the delay circuit does not have a chance to interrupt the signal on the signal SN, which sets or keeps the output of the data interpreter (e.g., node 525) to/at a high logic level.

However, if the signal on node 515 is a 40 ns signal, then the delay circuit will have a chance to reset the lower D-type flip-flop 730 before the upper D-type flip-flops 740 and 750 are clocked by a falling edge (40 ns later) of the signal at node 515. When reset, Q-node 730c of the lower D-type flip-flop 730 is set to high and the inverted Q-node 730d falls to a low logic level. Thus, when the falling edge of the signal at node 515 occurs, the D-input 740a to the upper left D-type flip-flop 740 just causes the Q-node 740a (i.e., the signal SN) to remain at a high logic level. But, the low logic level now at the D-input 750b of the upper right D-type flip-flop 750 causes its inverted Q-node 750d to transition high, i.e., the signal R pulses high. This signal pulses low for 1-2 ns because the upper right flip-flop 750 is substantially immediately reset (e.g., within 1-2 ns) by this very output signal. This high pulse on the signal R causes the output of the toggle flip-flop 760 to transition to a low logic level (if the output is not already low).

In the manner described above, the interpreter 520 generates on the node 525 a signal that substantially mimics the V_{IN} signal at the input node 105 (FIG. 1).

FIG. 8 is a circuit diagram of another embodiment of a time comparator circuit 700 that may be part of the receiver of FIG. 5. This circuit is an alternative embodiment to the embodiment of the time comparator of FIGS. 6 and 7. As before, a toggle flip-flop 760 has a Q-node coupled to the node 525 and may be controlled by its SN and R signals similar to the signals of the same name described above in conjunction with FIG. 7. That is, a low signal pulse (typically for 1-2 ns) at the SN node will cause the Q-node output to transition to a high logic level. Likewise, when a high signal pulse is present at the R node, the Q-node output transitions to a low logic value. Thus, the signals SN and R accomplish the same result, but are generated in a different manner as described below.

In this embodiment, when a signal at the node 515 is at a low logic level, the output of inverter 810 is high, which turns on the transistor N13. This pulls the node VP to a low logic level. The node VP is a first input to a differential amplifier 840 and therefore, the output of the amplifier is also at a low logic level when the input VP is low. The output of the amplifier 840 is coupled to the D-input of a first D-type flip-flop 850 via an inverter 851. Thus, the D-input is at a high logic level, which on a rising clock edge (of the signal at node 515) will cause the signal R at the inverted Q-node of the first flip-flop 850 to remain at a low logic level. The output of the amplifier 840 is also coupled to a second D-type flip-flop 860 via a second inverter 861. Then, a rising clock edge (of the signal at node 515) will cause the signal SN to pulse low.

On a rising edge of a signal at node 515 (i.e., either a 10 ns signal or a 40 ns signal is present), the transistor N13 turns off and the node VP begins to increase in voltage at a rate that is proportional to a delay associated with the current through transistor M13 and an RC circuit, where the transistor N10 forms a capacitor When the rising voltage at VP is compared to the threshold voltage V_{TH}, the resulting output will control the flip-flops 850 and 860.

Thus, when the voltage at VP rises above the threshold before the falling edge at node 515 (as may be typical with a 40 ns signal), then the output of the amplifier 840 will transition to a high logic level causing the D-input of the first flip-flop 850 to transition to a low logic level and the D-input of the second flip-flop 860 to transition to a high logic level. Then, at the falling edge of the signal at node 515, the first flip-flop 850 will be clocked so that the signal R pulses high. Thus, the output at node 525 transitions to a low logic level.

Conversely, if the signal at node 515 presents a falling edge before VP charges to above V_{TH} threshold, then the output of the amplifier remains at a low logic level and the D-input to the first flip-flop 850 is high while the D-input to the second flip-flop 860 is low. Therefore, on the falling edge of the signal at node 515, the first flip-flop will just keep the signal R at its logic low level. The second flip-flop 860 however, will cause the signal SN on its inverted Q-node output to pulse low, thus causing the flip flop 760 to generate or maintain a high logic level on the node 525.

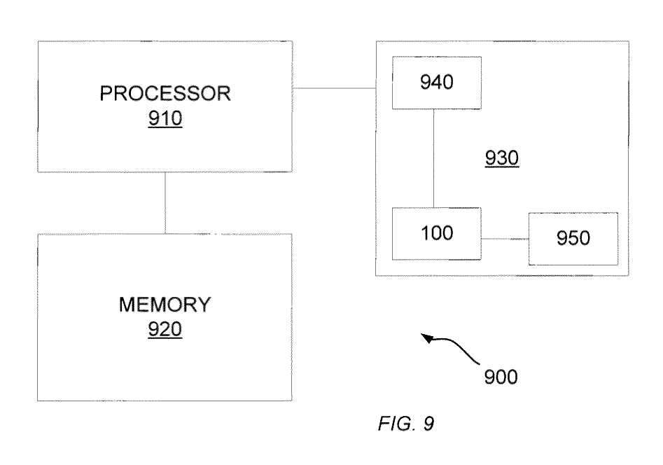

FIG. 9 is a block diagram of an embodiment of a system that may include the low-power optocoupler of FIG. 1. Such a system may be, for example, an electronic ignition switch for a vehicle or a power supply.

The system 900 may include a first integrated circuit component 930 having an optocoupler circuit 100 disposed thereon as well as additional electronic components, such as, for example, a processing unit 940 and a memory unit 950. The components of the first integrated circuit component 930 may be disposed on a single integrated circuit die or may be disposed on several distinct integrated circuit dies that may be part of a single component 930 package. Signals sent to and received from these additional components may be electrically isolated via the optocoupler 100.

Further, the first integrated circuit component 930 may also be coupled to additional components as part of the system 900 such as a separate processor 910 and a separate memory 920. Signals sent to and received from these off-chip components may also be electrically isolated via the optocoupler 100.

While the subject matter discussed herein is susceptible to various modifications and alternative constructions, certain illustrated embodiments thereof are shown in the drawings and have been described above in detail. Furthermore, those skilled in the art will understand that various aspects described in less than all of the embodiments may, nevertheless, be present in any embodiment. It should be understood, however, that there is no intention to limit the subject matter to the specific forms disclosed, but on the contrary, the intention is to cover all modifications, alternative constructions, and equivalents falling within the spirit and scope of the subject matter disclosed.

What is claimed is:

1. A device, comprising:
a drive circuit operable to receive an input signal including a parameter indicative of data carried by the input signal, the drive circuit further operable to generate a first signal corresponding to the received input signal, the first signal including a different parameter than the input signal that is indicative of the data;
a light-emitting diode coupled to the drive circuit and operable to be driven by the first signal;
a photo-diode optically coupled to the light-emitting diode and operable to generate a second signal corresponding to the first signal; and
a receiver circuit coupled photo-diode and operable to receive the second signal and interpret the second signal to generate an output signal that is the substantially the same as the input signal.

2. The device of claim 1 wherein the parameter comprises a width of a signal such that the input signal comprises a first signal width indicative of a first data and the first signal comprises a second signal width indicative of the first data.

3. The device of claim 1 the parameter comprises an amplitude such that the input signal comprises a first amplitude indicative of a first data and the first signal comprises a second amplitude indicative of the first data.

4. The device of claim 1 wherein the input signal comprises a series of logical signals, each logical signal comprising either a high logic level signal or a low logic level signal such that:
when received by the drive circuit, if a logical signal in the series of signals is a high logic level signal, then the drive circuit generates a signal having a first duration; and
if a logical signal in the series of signals is a low logic level signal, then the drive circuit generates a signal having a second duration.

5. The drive circuit of claim 4 wherein the first duration comprises 10 ns and the second duration comprises 40 ns.

6. The device of claim 1 wherein the input signal comprises a series of logical signals, each logical signal comprising either a high logic level signal or a low logic level signal such that:
when received by the drive circuit, if a logical signal in the series of signals is a high logic level signal, then the drive circuit generates a signal having a first amplitude; and
if a logical signal in the series of signals is a low logic level signal, then the drive circuit generates a signal having a second amplitude.

7. The device of claim 1 wherein the receiver circuit further comprises a time comparator circuit operable to:
receive the drive signal;
determine the duration of the drive signal; and
generate the output signal with a duration substantially the same as the corresponding input signal based upon the duration of the drive signal.

8. The device of claim 7 wherein the time comparator comprises:
a first flip flop operable to generate a first pulse when the input signal comprises a high logic level signal; and
a second flip flop operable to generate a second pulse when the input signal comprises a high logic level signal.

9. The device of claim 8 wherein the time comparator further comprises:
a third flip flop that may be reset by a pulse propagating through a series of delay elements such that:
if the third flip flop is reset, then the first flip flop generates the first signal; and
if the third flip flop is not reset, then the second flip flop generates the second signal.

10. The device of claim 8 wherein the time comparator further comprises:
an amplifier circuit operable to compare a control voltage to a threshold voltage such that:
if the control voltage exceeds the threshold voltage, then the first flip flop generates the first signal; and
if the control voltage does not exceed the threshold voltage, then the second flip flop generates the second signal.

11. The device of claim 1 wherein receiver circuit further comprises:
a conditioning circuit operable to condition the drive signal as it is received;
a trans-impedance amplifier coupled to the conditioning circuit for amplifying the drive signal;
a comparator coupled to the trans-impedance amplifier and operable to compare the amplified signal to a reference signal; and
a threshold generator coupled to the comparator for generating the reference signal.

12. An integrated circuit, comprising:
a drive circuit operable to receive an input signal including a parameter indicative of data carried by the input signal, the drive circuit further operable to generate a first signal corresponding to the received input signal, the first signal including a different parameter than the input signal that is indicative of the data;
a light-emitting diode coupled to the drive circuit and operable to be driven by the first signal;
a photo-diode optically coupled to the light-emitting diode and operable to generate a second signal corresponding to the first signal; and
a receiver circuit coupled photo-diode and operable to receive the second signal and interpret the second signal to generate an output signal that is the same as the input signal.

13. The integrated circuit of claim 12 comprising a single integrated circuit die.

14. The integrated circuit of claim 12, further comprising an input node operable to receive the input signal and an output node operable to receive the output signal.

15. A system, comprising:
a first integrated circuit operable to generate a first signal including a parameter indicative of data carried by the first signal;
an optocoupler coupled to the first integrated circuit, comprising:
a drive circuit operable to receive the first signal and operable to generate a second signal corresponding to the received first signal, the second signal including a different parameter than the first signal that is indicative of the data;
a light-emitting diode coupled to the drive circuit and operable to be driven by the second signal;
a photo-diode optically coupled to the light-emitting diode and operable to generate a third signal corresponding to the first signal; and
a receiver circuit coupled photo-diode and operable to receive the third signal and interpret the second signal to generate a fourth signal that is the same as the first signal; and
a second integrated circuit coupled to the optocoupler and operable to receive the fourth signal.

16. The system of claim 15 wherein the driver circuit and the receiver circuit are each disposed on separate integrated circuit dies.

17. The system of claim 15 wherein the first circuit and the second circuit are electrically isolated from each other.

18. The electronic system of claim 15 wherein the first integrated circuit comprises a processor and the second integrated circuit comprises a memory.

19. A method, comprising:
receiving a first signal at a node, the first signal having a first signal width indicative of underlying data;
generating a second signal having a smaller signal width in response to receiving the first signal indicative of the underlying data;
transmitting the second signal to a second node; and
generating a third signal having the first signal width indicative of the underlying data in response to receiving the second signal at the second node.

20. The method of claim 19, further comprising:
driving a light-emitting diode with the second signal; and
receiving a light signal from the light-emitting diode at a photo diode coupled to the second node.

21. The method of claim 20 further comprising generating a fourth signal from the photo-diode that is substantially similar to the second signal.

22. The method of claim 20, further comprising:
determining the duration of the received light signal;
if the determined duration is substantially 10 ns, then generating a signal to transition an output signal from a low logic level to a high logic level; and
if the determined duration is substantially 40 ns, then generating a signal to transition the output signal from a high logic level to a low logic level.

23. A method, comprising:
receiving a series of logical signals at a first node;
in response to detecting a rising edge in the series of logical signals, generating a signal having a first duration at a second node; and
in response to detecting a falling edge in the series of logical signals, generating a signal having a second duration at a second node.

24. The method of claim 23, further comprising:
generating the signal of the first duration by setting a first flip-flop output; and
generating the signal of the second duration by setting a second flip-flop output.

25. The method of claim 23, further comprising:
transmitting the signal to a receiver circuit;
interpreting the signal to generate an output signal such that if the signal is of the first duration, interpreting a high logic level signal; and
if the signal is of the second duration, interpreting a low logic level signal.

26. A method, comprising:
receiving a series of signals at a first node;
in response to detecting a signal having a first duration in the series of signals, generating a rising edge of a logical signal at a second node; and
in response to detecting a signal having a second duration in the series of signals, generating a falling edge of a logical signal at a second node.

27. A device, comprising:
a drive circuit operable to receive a first signal including a parameter indicative of data carried by the first signal, the drive circuit further operable to generate a second signal corresponding to the received input signal, the second signal including a different parameter than the first signal that is indicative of the data; and
a light-emitting diode coupled to the drive circuit and operable to be driven by the second signal.

28. The device of claim 27 further comprising an integrated circuit disposed on a single die.

29. The device of claim 27 wherein the parameter comprises the duration of a signal such that:
if the received signal comprises a high logic level signal, then the drive circuit generates a signal having a first duration; and
if the received signal comprises a low logic level signal, then the drive circuit generates a signal having a second duration.

30. The device of claim 29 wherein the first duration comprises 10 ns and the second duration comprises 40 ns.

31. A device, comprising:
a photo-diode operable receive a first signal including a parameter indicative of data carried by the first signal; and
a receiver circuit coupled photo-diode and operable to receive the first signal and interpret the first signal to generate a second signal including a different parameter than the first signal that is indicative of the data.

32. The device of claim 31 comprising an integrated circuit disposed on a single die.

33. The device of claim 31 wherein the parameter comprises the duration of a signal such that:
if the first signal comprises a first duration, then the receiver circuit generates a signal having a high logic value; and
if the first signal comprises a second duration, then the receiver circuit generates a low logic value.

34. The device of claim 33 wherein the first duration comprises 10 ns and the second duration comprises 40 ns.

35. A method, comprising:
receiving a first signal at a node, the first signal having a first signal amplitude indicative of underlying data;
generating a second signal having a duration in response to receiving the first signal indicative of the underlying data; and
transmitting the second signal to a second node.

36. A method, comprising:
receiving a first signal having a duration indicative of underlying data;
determining the duration of the first signal; and
generating a second signal having the amplitude indicative of the underlying data in response to receiving the first signal.
